(19) United States
(12) Patent Application Publication
(10) Pub. No.: US 2013/0212088 A1
(43) Pub. Date: Aug. 15, 2013

(54) MOBILE DEVICE HAVING A MEMO FUNCTION AND METHOD FOR EXECUTING A MEMO FUNCTION

(71) Applicant: Samsung Electronics Co., Ltd., (US)

(72) Inventor: An-Na Park, Seoul (KR)

(73) Assignee: Samsung Electronics Co., Ltd., Gyeonggi-do (KR)

(21) Appl. No.: 13/764,157

(22) Filed: Feb. 11, 2013

(30) Foreign Application Priority Data
Feb. 9, 2012 (KR) 10-2012-0013224

(51) Int. Cl. G06F 17/30

(52) U.S. Cl. CPC G06F 17/30386
USPC 707/722

(57) ABSTRACT

A method and mobile device having a memo function are provided. The mobile device includes a memo processor; a memory; and a controller. The controller recognizes an occurrence of an event, determines whether an event key value corresponding to the occurring event already exists, and when the event key value corresponding to the occurring event does not already exist, controls the memo processor to generate an event key value corresponding to the occurring event receives an input of memo data according to a memo generation request and to map the generated event value and the input memo data to each other, and stores the mapped event value and memo data in the memory.

### PRIORITY

This application claims priority under 35 U.S.C. §119(a) to Korean Patent Application Serial No. 10-2012-0013224, which was filed in the Korean Intellectual Property Office Feb. 9, 2012, the entire disclosure of which is hereby incorporated by reference.

### BACKGROUND OF THE INVENTION

1. Field of the Invention

The present invention relates generally to a mobile device and method, and more particularly, to a method and mobile device having a memo function that generates a memory anywhere in the device and accesses a previously generated memory.

2. Description of the Related Art

Recently, memo applications have gained in popularity for use in mobile devices.

Generally, a user downloads a memo application from an application provider and installs the memo application in a mobile device. Thereafter, when the user desires to generate a memo using the installed memo application, the user executes the memo application, generates a memo, and stores the generated memo. When the user then wants to check previously generated memos, the user executes the memo application, retrieves a stored memo or selects one from a list of stored memos, and then views content of the memo displayed through the memo application.

As described above, a conventional memo application is installed in a mobile device and to use a memo function, i.e., to generate or view a memo, the memo application is executed. Further, using the conventional memo application, a memo may be generated and viewed only in a particular memo application.

Consequently, a memo cannot be viewed without execution of a particular memo application, such that accessibility of the memo is low.

Further, because a conventional memo application is specified to a format such as a text or image attachment, it is difficult to generate memos in various formats, thereby limiting a user's desires.

### SUMMARY OF THE INVENTION

Accordingly, the present invention is designed to address at least the problems and/or disadvantages described above and to provide at least the advantages described below.

An aspect of the present invention is to provide a mobile device that performs a memo function in any environment therein, and a method for executing the memo function.

In accordance with an aspect of the present invention, a mobile device having a memo function is provided. The mobile device includes a memo processor, a memory, and a controller. The controller recognizes an occurrence of an event, determines whether an event key value corresponding to the occurring event already exists, and when the event key value corresponding to the occurring event does not already exist, controls the memo processor to generate an event key value corresponding to the occurring event receives an input of memo data according to a memo generation request and to map the generated event value and the input memo data to each other, and stores the mapped event value and memo data in the memory.

In accordance with another aspect of the present invention, a method is provided for executing a memo function in a mobile device. The method includes recognizing an occurrence of an event; determining whether an event key value corresponding to the occurring event already exists; generating an event key value corresponding to the occurring event, when the event key value corresponding to the occurring event does not already exist; receiving an input of memo data according to a memo generation request; mapping the generated event value and the input memo data to each other; and storing the mapped event value and memo data.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a mobile device according to an embodiment of the present invention;

FIG. 2 is a block diagram illustrating a memo processor according to an embodiment of the present invention;

FIG. 3 is a flowchart illustrating a process of generating a memo according to an embodiment of the present invention;

FIG. 4 is a flowchart illustrating a process of displaying a previously generated memo according to an embodiment of the present invention;

FIG. 5 illustrates an example of a table in which an event key value corresponding to an event and a generated memo are mapped to each other, according to an embodiment of the present invention;

FIG. 6 illustrates an example of a screen display when executing a memo mode according to an embodiment of the present invention;

FIG. 7 illustrates an example of a screen display when generating a memo according to an embodiment of the present invention;

FIG. 8 illustrates an example of a screen display when displaying a memo according to an embodiment of the present invention;

FIG. 9 illustrates an example of a screen display when displaying a memo including multimedia data according to an embodiment of the present invention;

FIG. 10 illustrates an example of a screen display for memo security according to an embodiment of the present invention;

FIG. 11 illustrates an example of a screen display for a memo alarm according to an embodiment of the present invention; and

FIG. 12 is a logic diagram of a memo processor executing a memo function according to an embodiment of the present invention.

### DETAILED DESCRIPTION OF EMBODIMENTS OF THE INVENTION

Various embodiments of the present invention will be described in detail below with reference to the accompanying drawings. Specific details, such as detailed configuration and components, are merely provided to assist the overall understanding of the present invention. Therefore, it should be apparent to those skilled in the art that various changes and modifications of the embodiments described herein can be made without departing from the scope and spirit of the invention. Further, in the following description and accompanying drawings, well-known functions and structures will not be provided if they unnecessarily obscure the subject matter of the present invention.

In accordance with an embodiment of the present invention, an event key value is generated corresponding to an event occurrence, a memo input screen is displayed, when there is a memo generation request in a memo mode executed in response to a memo mode execution request, and input memo data and the generated event key value are stored in a mapped manner to (or in association with) each other.

In accordance with another embodiment of the present invention, upon an occurrence of an event, the existence of an event key value corresponding to the event is checked, and a memo including memo data stored to be mapped to the occurring event key value is displayed, when the event key value exists.

Accordingly, a user can generate a memo in any environment in a mobile device and display the generated memo.

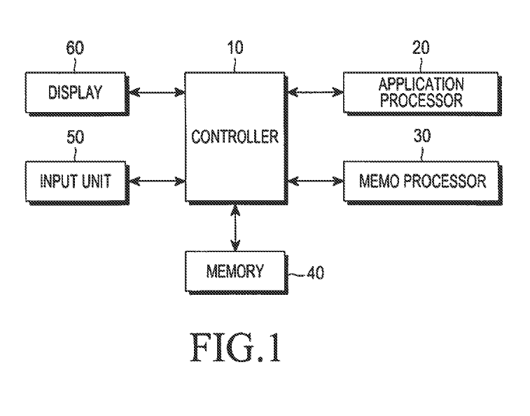

FIG. 1 is a block diagram illustrating a mobile device according to an embodiment of the present invention.

Referring to FIG. 1, the mobile device includes a controller 10, an application processor 20, a memo processor 30, a memory 40, an input unit 50, and a display 60.

The controller 10 controls an overall operation of the mobile device, and in particular, executes a memo mode in response to a memo mode execution request. Herein, the memo mode is a state mode for generating a memo in any environment in the mobile device. In accordance with an embodiment of the present invention, a memo Application Program Interface (API) for executing a memo function in a platform is added to generate or display a memo, even on a standby screen or in an application-running state.

Upon an occurrence of an event, such as an execution of a particular application, the controller 10 generates an event key value corresponding to the occurring event through the memo processor 30. For example, upon an occurrence of an event for executing a household account book application, the controller 10 executes the household account book application through the application processor 20 and generates an event key value “key_{—}02” corresponding to execution of the household account book application.

If there is a memo generation request for memo generation, the controller 10 configures a memo input screen for memo generation and displays the memo input screen through the display 60. The memo input screen may include a screen configuration for inputting a text and a screen configuration for attaching multimedia data other than a text, such as music, recordings, pictures, video data, etc. The memo input screen may further include a screen configuration for attaching Global Positioning System (GPS) location information of a mobile device or setting an alarm.

Upon input of memo data through the input unit 50, the controller 10 controls the memo processor 30 to store the input memo data and the generated event key value in a mapped manner to each other in the memory 40. For example, upon input of memo data in which a “shopping basket picture” is attached together with a text “shopping” through the input unit 50, the controller 10 stores the generated event key value “key_{—}02” and the input memo data “shopping” and “shopping basket picture” in a mapped manner to each other in the memory 40.

If an event occurs during execution of the memo mode, the controller 10 determines whether an event key value corresponding to the occurring event exists. If the corresponding event key value exists, the controller 10 reads memo data that is mapped to the event key value from the memory 40 and displays the read memo data through the display 60.

For example, when a request for executing a household account book application is input, the controller 10 executes a household account book application through the application processor 20, and when the event key value “key_{—}02” corresponding to execution of the household account book application exists, the controller 10 reads memo data, i.e., the text “shopping” and the “shopping basket picture”, which are mapped to the event key value “key_{—}02”, from the memory 40, and displays the read memo data through the display 60.

When an event key value corresponding to the occurring event does not exist, the controller 10 generates the event key value corresponding to the occurring event. The controller 10 may then perform the above-described operations following the generation of the event key value.

When there is a request to execute an application, the application processor 20 executes or terminates the requested application under control of the controller 10.

Upon an occurrence of an event in the memo mode, the memo processor 30 generates an event key value corresponding to the occurring event, and upon input of memo data through the memo input screen displayed in response to the memo generation request, the memo processor 30 stores the generated event key value and the input memo data in a mapped manner to each other, in the memory 40.

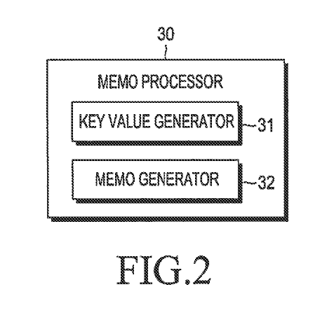

FIG. 2 is a block diagram illustrating a memo processor according to an embodiment of the present invention.

Referring to FIG. 2, the memo processor 30 includes a key value generator 31 and a memo generator 32.

The key value generator 31 generates an event key value corresponding to an event. For example, upon an execution of a household account application, the key value generator 31 generates an event key value “key_{—}02” corresponding to the execution of the household account application.

The key value generator 31 may also generate an event key value corresponding to a current device state when there is a memo generation request. For example, when a memo generation request is received while the mobile device is in a standby screen state, the key value generator 31 generates an event key value corresponding to the standby screen. If there is a memo generation request when the household account book application is executed, the key value generator 31 generates an event key value corresponding to execution of the household account book application.

The memo generator 32 stores the memo data input through the input unit 50 and the generated event key value in a mapped manner to each other, in the memory 40. For example, upon the input of the text “shopping” through the input unit 50, the memo generator 32 stores the event key value “key_{—}02” corresponding to the execution of the household account book application and the input text “shopping” in a mapped manner to each other, in the memory 40.

The memory 40 stores overall data used in the mobile device, especially, an event key value generated by the memo processor 30 and memo data mapped to the event key value.

The input unit 50 includes a plurality of key buttons for key inputs and delivers a key signal corresponding to a key input generated by pressing of a key button to the controller 10. Additionally, the input unit 50 may include a touch screen or a touch pad for sensing a touch input and outputting a key signal.

The display 60 displays a plurality of operating screens including an application execution screen corresponding to execution of an application and a memo input screen according to a memo generation request. The display 60 also displays previously stored memo data upon occurrence of an event.

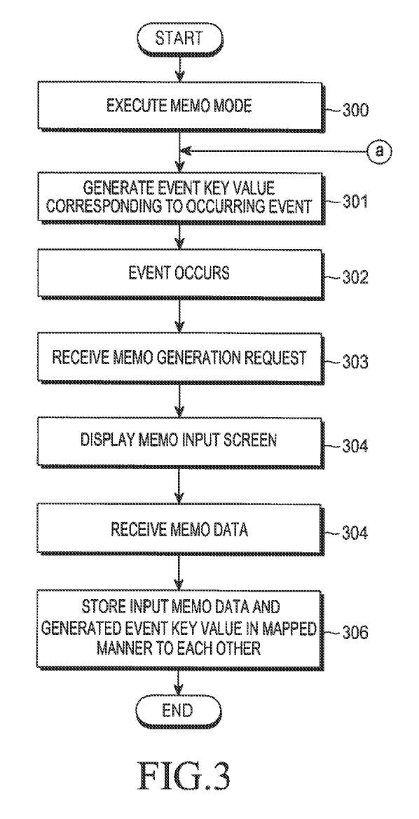

FIG. 3 is a flowchart illustrating a process of generating a memo according to an embodiment of the present invention.

Referring to FIG. 3, in step 300, the controller 10 executes a memo mode in response to a memo mode execution request. In accordance with an embodiment of the present invention, a screen for inputting a memo mode execution request is configured and displayed, such that the user may request the execution of the memo mode on the displayed screen.

Upon an occurrence of an event in the memo mode, the controller 10 generates an event key value corresponding to the event in step 302.

In step 303, the controller 10 receives a memo generation request.

In step 304, the controller 10 displays a memo input screen for inputting memo data. The memo input screen refers to a screen for inputting text and multimedia data, such as music, recordings, pictures, video, etc.

In step 305, the controller 10 receives the memo data input through the input unit 50.

In step 306, the controller 10 stores the input memo data and the generated event key value in a mapped manner to each other, in the memory 40.

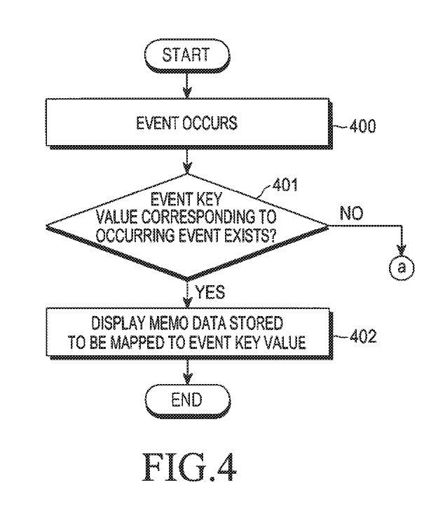

FIG. 4 is a flowchart illustrating a process of displaying a previously generated memo according to an embodiment of the present invention. Specifically, FIG. 4 illustrates a process of displaying a previously generated memo, when the mobile device is already set to the memo mode.

Referring to FIG. 4, upon occurrence of an event in step 400, the controller 10 determines whether an event key value corresponding to the occurring event exists in step 401. When no event key value exists, the process goes to step (a) of FIGS. 3 to generate the event key value corresponding to the occurring event in step 302 of FIG. 3. Thereafter, the controller 10 performs steps 303 through 306 of FIG. 3, as described above.

However, when a corresponding event key value exists, the controller 10 retrieves and displays the memo data that is mapped to the event key value in step 402

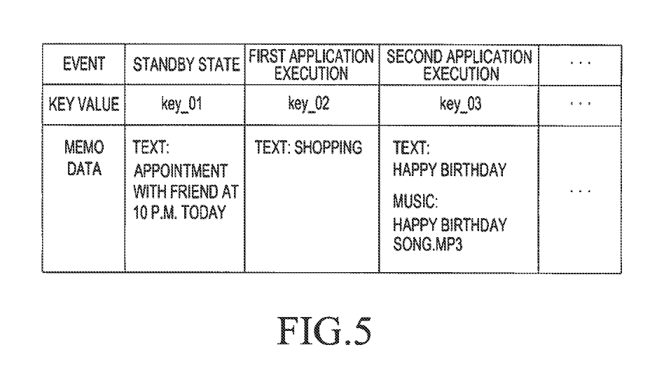

FIG. 5 illustrates a table in which an event key value corresponding to an event and a generated memo are mapped to each other, according to an embodiment of the present invention.

Specifically, the controller 10 maps an event key value corresponding to an occurring event to input memo data to configure the table as illustrated in FIGS. 5, and stores the configured table in the memory 40. That is, using the table illustrated in FIG. 5, an event key value corresponding to a type of an event is mapped to input memo data.

For example, referring to FIG. 5, when the mobile device is in a standby screen 5 state, upon receiving a memo generation request, the key value generator 31 of the memo processor 30 generates “key_{—}01” as an event key value corresponding to a standby screen. When a text “appointment with friend at 10 p.m. today” is input as memo data, the controller 10 maps “key_{—}01” to “appointment with friend at 10 p.m. today” and stores them in the memory 40. Thereafter, the controller 30 displays a memo including the memo data, the text “appointment with friend at 10 p.m. today”, on the standby screen of the mobile device through the display 60.

When an event key value “key_{—}02” corresponding to execution of a first application (household account book application) and memo data, a text “shopping” are stored in a mapped manner to each other, as illustrated in FIG. 5, in response to a first application execution request, the controller 10 executes the first application through the application processor 20 and displays a memo including memo data, the text “shopping” stored in a mapped manner to the event key value “key_{—}02” corresponding to execution of the first application through the display 60.

When an event key value “key_{—}03” corresponding to execution of a second application and memo data, i.e., a text “Happy birthday” and a music file “happy birthday song. mp3”, are stored in a mapped manner to each other, as illustrated in FIG. 5, in response to a second application execution request, the controller executes the second application through the application processor 20 and displays a memo including the memo data stored in a mapped manner to the event key value “key_{—}03” corresponding to execution of the second application, the text “Happy birthday” and the music file “happy birthday song. mp3”, through the display 60.

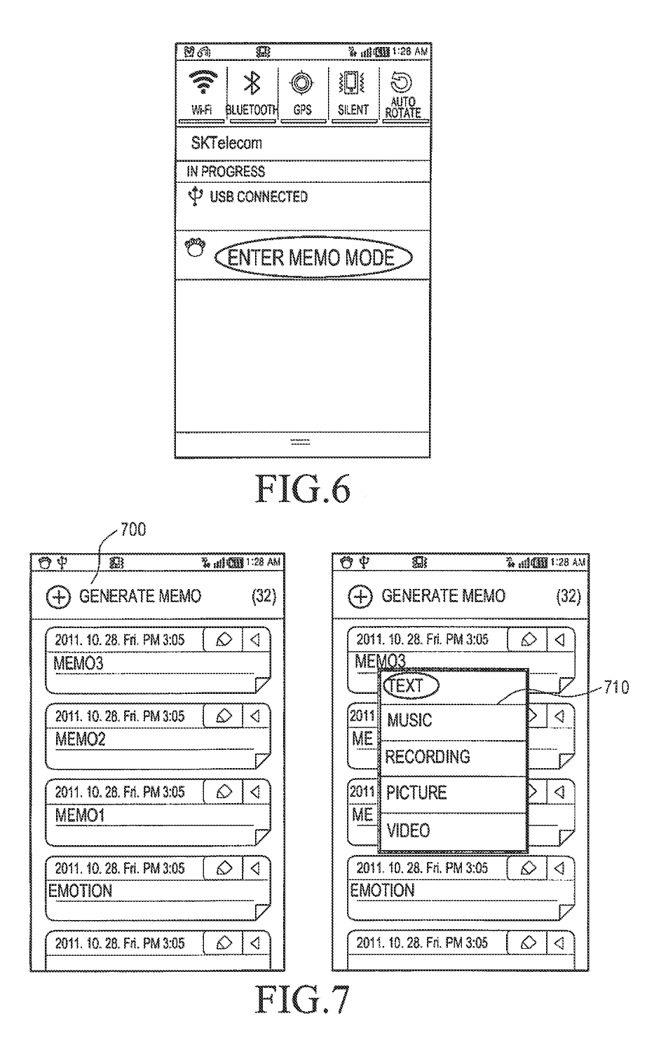

FIG. 6 illustrates an example of a screen display when executing a memo mode according to an embodiment of the present invention.

Referring to FIG. 6, the controller 10 configures and displays a menu screen for entry to the memo mode in response to a memo mode setting request. The user sets the memo mode when desiring to use a memo through the menu screen.

FIG. 7 illustrates an example of a screen display when generating a memo according to an embodiment of the present invention.

Referring to FIG. 7, upon selection of a menu item 700 for memo generation through the input unit 50, the controller 10 displays a menu screen 710 for selecting a type of content to be added in the memo generation. Accordingly, the user can include text data and multimedia data, such as music data, recording data, picture data, video data, etc., in a memo.

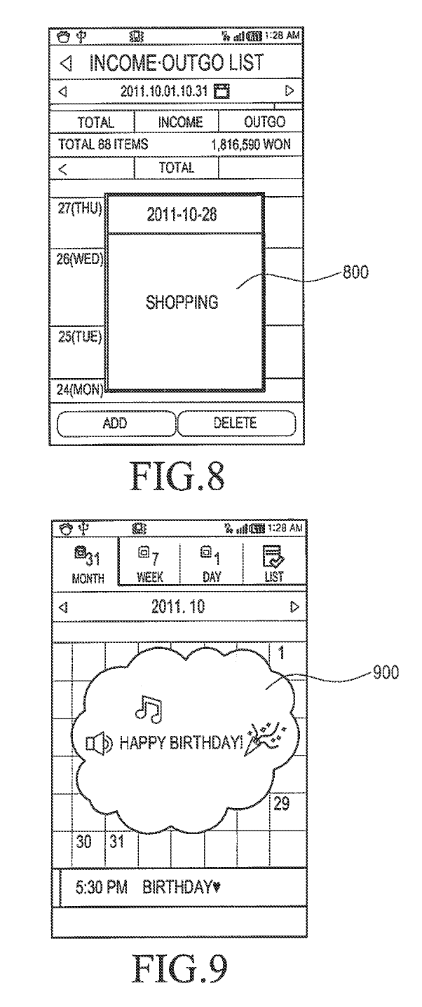

FIG. 8 illustrates an example of a screen display when displaying a memo according to an embodiment of the present invention.

Referring to FIG. 8, in response to a request for executing a household account book application, the controller 10 executes a household account book application and determines whether an event key value corresponding to execution of the household account book application exists. When the corresponding event key value exists, the controller 10 configures a memo 800 including the stored memo data corresponding to the event key value, e.g., a text “2011-10-28 Shopping!!” and displays the memo 800 through the display 60.

FIG. 9 illustrates an example of a screen display when displaying a memo including multimedia data according to an embodiment of the present invention.

In accordance with an embodiment of the present invention, a function for inputting date and time information for an alarm is further provided in memo generation, thus allowing the user to input date and time information according to which the generated memo is to be displayed. Thus, the controller 10 may additionally configure a region for inputting date and time information for an alarm on the memo input screen.

Referring to FIG. 9, upon input of memo data including the text “Happy birthday” and the music data “happy birthday song. mp3” with date and time information for an alarm at 5:30 p.m. on Oct. 28, 2011 in memo generation, the controller 10 generates an event key value corresponding to the date and time information and stores the generated event key value and the input memo data in a mapped manner to each other. Herein, the event indicates a date and a time on the mobile device, which matches the corresponding date and time information.

When the date and the time of the mobile device are Oct. 28, 2011 and 5:30 p.m., the controller 10 configures a memo 900 by using the memo data stored in a mapped manner to the event key value corresponding to the date and time information, and displays the memo 900 through the display 60.

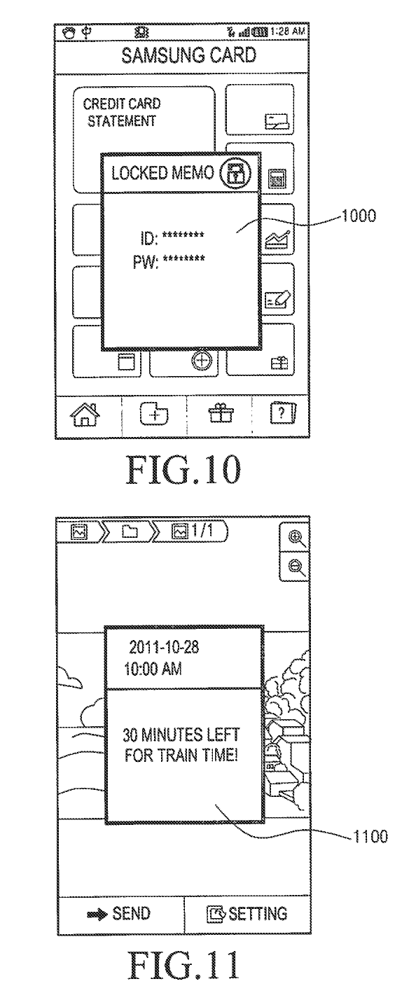

FIG. 10 illustrates an example of a screen display for memo security according to an embodiment of the present invention.

In accordance with an embodiment of the present invention, for memo security, a user ID and password may be set, as illustrated in FIG. 10. For example, according to the memo generation request during execution of a banking-related application, the controller 10 generates an event key value corresponding to execution of the banking-related application and displays a memo input screen for memo generation. In this case, the memo input screen may further include a region for setting a user ID and password for security of the generated memo.

Thereafter, when the banking-related application is executed, the controller 10 displays a memo stored in a mapped manner to the event key value corresponding to execution of the application on the screen, and if security is set, the controller 10 displays an input screen 1000 for inputting the user ID and password. When the user ID and the 10 password previously set by the user are correctly input, the controller 10 releases the memo security and displays the stored memo on the screen. However, otherwise, unless the previously set ID and password are correctly input, the controller 10 maintains memo security.

FIG. 11 illustrates an example of a screen display for a memo alarm according to an embodiment of the present invention.

In accordance with an embodiment of the present invention, memo generation and memo display for an alarm may be possible using location information of the mobile device. Thus, the controller 10 may further include a location setting region for setting a location for an alarm on the memo input screen for memo generation.

For example, referring to FIG. 11, according to the memo generation request, the controller 10 displays the memo input screen for memo generation, and upon input of memo data, e.g., “30 minutes left for train time!” with location information of “train station” for an alarm through the input unit 50, the controller 10 generates an event key value corresponding to the location information of “train station” and stores the generated event key value and the input memo data in a mapped manner to each other, in the memory 40. The location information may be an address of a particular place or location information on the map.

Thereafter, when the location of the mobile device is close to the input location information, the controller 10 displays a memo 1100 including memo data stored to be mapped to the location information on the screen.

Although not illustrated in FIG. 1, a GPS receiver may also be further included in the mobile device, such that upon occurrence of an event in which the location of the mobile device is close to previously set location information, the controller 10 displays stored memo data that is mapped to an event key value corresponding to the occurring event on the screen. The controller 10 determines that the location of the mobile device is close to the previously set location information when the mobile device is located within a threshold distance from the previously set location information. For example, the controller 10 determines that the location of the mobile device is close to the previously set location information, when the mobile device is located within a radius of 100 meters from the previously set location information.

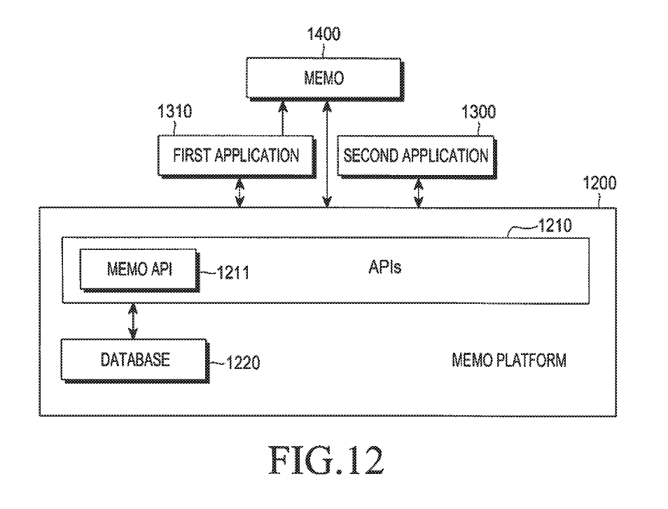

FIG. 12 is a logic diagram of a memo processor executing a memo function according to an embodiment of the present invention.

Referring to FIG. 12, the memo processor includes APIs 1210 including functions that run at least one application in a memo platform 1200, a memo API 1211 including functions that run a memo, such as execution and display of a memo, in the APIs 1210, and a database 1220 for storing information that runs the at least one applications and information that runs a memo.

In response to a memo generation or display request, the memo API 1211 reads the information that runs the memo function from the database 1220 and applies the read information to a function to run a memo 1400. Because the memo 1400 is run through the memo API 1211 in the memo platform 1200, the memo 1400 can be run even when a first application 1310 and a second application 1300 are run.

Further, a generated memo may be shared with other users through network connection such as WiFi or Bluetooth or a network service such as an e-mail, a text message, a Social Network Service (SNS), etc. Thus, a memo and contents attached thereto may be shared over a large area as well as in a local device.

Additionally, the above-described embodiments of the present invention can be implemented with hardware or a combination of hardware and software. Such software may be stored, whether or not erasable or re-recordable, in a volatile or non-volatile storage such as a Read-Only Memory (ROM); a memory such as a Random Access Memory (RAM), a memory chip, a device, or an integrated circuit; and an optically or magnetically recordable and machine (e.g., computer)-readable storage medium such as a Compact Disc (CD), a Digital Versatile Disk (DVD), a magnetic disk, or a magnetic tape. The virtual space moving method according to the present invention can be implemented by a computer or a portable terminal which includes a controller and a memory, and it can be seen that a storing unit may be an example of a machine-readable storage medium which is suitable for storing a program or programs including instructions for implementing the embodiment of the present invention. Therefore, the present invention includes a program including codes for implementing an apparatus or method claimed in an arbitrary claim and a machine-readable storage medium for storing such a program. The program may be electronically transferred through an arbitrary medium such as a communication signal delivered through wired or wireless connection, and the present invention properly includes equivalents thereof.

The mobile device may receive and store the program from a program providing device connected in a wireless or wired manner. The program providing device may include a memory for storing a program including instructions allowing the mobile device to perform a previously set memo function execution method, a memory for storing information necessary for the memo function execution method, a communication unit for performing wired or wireless communication with the mobile device, and a controller for transmitting the program to the mobile device at the request of the mobile device or automatically.

Accordingly, the above-described embodiments of the present invention provide a mobile device that displays a memo in any environment in the mobile device, improving user convenience.

Further, according to the above-described embodiments of the present invention, in a memo, a text is provided and media content data such as voice, recordings, pictures, moving pictures, etc., may be attached or reproduced.

Furthermore, the above-described embodiments of the present invention allow a generated memo to be shared with other users through a network service, such that contents are available over a large area as well as in a local device.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A mobile device having a memo function, the mobile device comprising:
a memo processor;
a memory; and
a controller that recognizes an occurrence of an event,
determines whether an event key value corresponding to the occurring event already exists, and
when the event key value corresponding to the occurring event does not already exist, controls the memo processor to generate an event key value corresponding to the occurring event receives an input of memo data according to a memo generation request and to map the generated event value and the input memo data to each other, and stores the mapped event value and memo data in the memory.

2. The mobile device of claim 1, wherein when the event key value corresponding to the occurring event already exists, the controller displays stored memo data that corresponds to the existing event key value.

3. The mobile device of claim 1, wherein the event comprises a standby screen state of the mobile device, and
wherein the event key value comprises a standby screen key value corresponding to the standby screen state of the mobile device.

4. The mobile device of claim 4, wherein the controller displays the memo data mapped with the standby screen key value, when the mobile device is in the standby screen state.

5. The mobile device of claim 1, wherein the event comprises an application execution, and
wherein the event key value comprises an application execution key value corresponding to the application execution.

6. The mobile device of claim 5, wherein the controller displays the memo data mapped with the application execution key value, upon an execution of the application.

7. The mobile device of claim 1, wherein the event comprises date and time information, and
wherein the event key value comprises a date and time information key value corresponding to the date and time information input with the memo data according to the memo generation request.

8. The mobile device of claim 7, wherein the controller displays the memo data mapped with the date and time information key value, when a current date and time match the date and time information.

9. The mobile device of claim 1, wherein the event comprises location information of a particular place, and
wherein the event key value comprises a location information key value corresponding to the location information of the particular place input with the memo data according to the memo generation request.

10. The mobile device of claim 9, wherein the controller displays the memo data mapped with the location information key value, when a location of the mobile device is within a predetermined range of a location identified by the location information of the particular place.

11. A method for executing a memo function in a mobile device, the method comprising:
recognizing an occurrence of an event;
determining whether an event key value corresponding to the occurring event already exists;
generating an event key value corresponding to the occurring event, when the event key value corresponding to the occurring event does not already exist;
receiving an input of memo data according to a memo generation request;
mapping the generated event value and the input memo data to each other; and
storing the mapped event value and memo data.

12. The method of claim 11, further comprising displaying stored memo data that corresponds to the event key value, when the event key value corresponding to the occurring event already exists.

13. The method of claim 11, wherein the event comprises a standby screen state of the mobile device, and
wherein the event key value comprises a standby screen key value corresponding to the standby screen state of the mobile device.

14. The method of claim 13, further comprising:
displaying the memo data mapped with the standby screen key value on the screen, when the mobile device is in the standby screen state.

15. The method of claim 11, wherein the event comprises an application execution, and
wherein the event key value comprises an application execution key value corresponding to the application execution.

16. The method of claim 15, further comprising:
displaying the memo data mapped with the application execution key value, upon an execution of the application.

17. The method of claim 11, wherein the event comprises date and time information, and
wherein the event key value comprises a date and time information key value corresponding to the date and time information input with the memo data according to the memo generation request.

18. The method of claim 17, further comprising:
displaying the memo data mapped with the date and time information key value, when a current date and time match the date and time information.

19. The method of claim 11, wherein the event comprises location information of a particular place, and
wherein the event key value comprises a location information key value corresponding to the location information of the particular place input with the memo data according to the memo generation request.

20. The method of claim 19, further comprising:
